(19) United States
(12) Patent Application Publication
(10) Pub. No.: US 2012/0246230 A1
(43) Pub. Date: Sep. 27, 2012

(54) SYSTEM AND METHOD FOR A SOCIAL NETWORKING PLATFORM

(76) Inventors: Domen Ferbar, Ljubljana (SI); Janez Ferbar, Ljubljana (SI); Janez Guzelj, Dobrova (SI); Janez Juvancic, Ortnek (SI)

(21) Appl. No.: 13/053,425

(22) Filed: Mar. 22, 2011

(51) Int. Cl. G06F 15/16

(52) U.S. Cl. 709/204

(57) ABSTRACT

The present invention generally relates to online social networking Specifically, this invention relates to a system and method for providing a content evaluation and social networking platform that allows users to interact through the use of various roles, develop reputations through a personal and peer based rating system and exchange goods and services through use of an online currency that may be traded and exchanged in various real world currencies.

### FIELD OF THE INVENTION

The present invention generally relates to online social networking. Specifically, this invention relates to a system and method for providing a content evaluation and social networking platform that allows users to interact through the use of various roles, develop reputations through a personal and peer based rating system and exchange goods and services through use of an online currency that may be traded and exchanged in various real world currencies.

### BACKGROUND OF THE INVENTION

Current social networking systems allow a user to sign up and communicate with their friends, peers, colleagues, coworkers or other individuals they share some common interest with. These connections are made typically through requests and most commonly must be mutually accepted before certain functionality is allowed between the two or more individuals. The connections usually provide the ability to users to share content amongst and between themselves.

One problem with current social networking systems is that a user may typically only sign up using a single account and create connections under that single account. One drawback of this is that the various roles in an individual's life may all get skewed into one place. In this manner, a user is forced to have his friends, peers, colleagues, coworkers and other individuals all lumped into a single place where certain undesirable information may become public or presented to individuals the user did not want to have access to said undesirable information. For instance, a user's friends may share stories about the user that the user would not want his coworkers to know about. Since the user only has one conglomerated space, there is no way to prevent coworkers from seeing this information.

Therefore, there is a need in the art for a system and method for providing a social networking platform that allows users to separate out the various roles and aspects of their lives as they deem appropriate.

Additionally, in some social networking systems, a user may not only create a connections with other individuals, but they may also be able to rate certain content associated with that user (e.g., photos, articles, comments, forum posts). From these ratings, a user may garner a reputation, usually calculated as a score. These reputation scores help other individuals know how reputable or prolific a given user is.

While providing ratings of content and reputation scores based on user and content ratings is useful, there is no ability to know how accurate an accumulated reputation or rating is in context with an individual user's knowledge, taste and preference. Some systems provide the ability to predict the likelihood that an individual will enjoy or find useful a particular piece of content through simple matching methods (e.g., user 1 likes content 1, user 1 likes content 2, user 2 likes content 1, so therefore, user 2 might like content 2 based on user 1's liking of content 2).

Another problem with ratings and content prediction systems currently used is that they allow a particular user the ability to tell the system about himself/herself. In this manner, the system's view of the particular user is defined by the particular user, and not by any outside influence or regards. For example, if a user says or otherwise indicates they are an expert in software programming, the system believes the user is an expert in software programming.

Additionally, current systems only provide reputations that are not content specific. For instance, a system may have no dedicated topic area and the users are able to develop reputations, however these reputations are not in relation to any specific topic. Another example is where a system is dedicated to a specific topic, and where a user wants to discuss a similar topic, but one that is not allowed on the specific system, the user must go to another system and begin anew with building their reputation on the new system.

To be specific, in the current state of the art, a user will typically “build” one reputation on one site. If the site is dedicated to a specific type of content, so is the reputation. If the site is not “dedicated”—the reputation is less specific. The user may also build a second reputation on a second site on another “topic”, but there is no relation between those reputation.

Currently, there are two main options for users in relation to online reputations:
1. a site has no “dedicated” topic, and a reputation built there is not content specific; or
2. a site is dedicated to a certain topic, and the reputation built there is content specific, but similar (or dissimilar) topics are not accepted on this site and user must move to another site, where he must build his reputation anew.

Ranking, evaluation and grading of the content published on the Internet has gone through the following three major phases:
1. Numerical average—the first and simplest phase is when the numerical average is used. This is where unidentified consumers (or consumers with “limited”/non global identity) evaluate a product or service on a scale and the result is shown as the calculated average of these evaluations.
2. Numerical average plus descriptive evaluation—the second and more developed phase is where a descriptive evaluation is added to the numerical evaluation. Users (consumers) write about their own experiences or opinions relating to the product or service in forums and blogs.
3. Judgment and referrals—the third phase is where users can in some way trust the judgment and referrals of friends that they connect to through social networks.

The problem with the first approach is that there is no verification that the person who has completed the evaluation has any credentials that allow him/her to provide an opinion that is valid. Another major problem with the first approach is that there is a “democracy problem”. A random person visiting the website in question usually has little interest in the average opinion of the majority, but rather he/she has a great deal of interest in the opinions of people just like him or her.

The issue with the second approach is that estimates given by users are subjective and the observer cannot know whether he can trust them. He or she also does not know how similar the preferences and experiences of reviewers are to his or her own preferences and experiences.

Social networks try to solve both problems by substantiating the weight of estimates on friendship relations. Here a problem occurs because on the one hand the number of friends whose opinion one trusts is limited and, on the other hand, the social context usually does not provide a variety of people large enough to cover most of one's interests. Thus the number of areas and the number of evaluations that the average opinion seeker needs is usually beyond the experiences of his or her trusted friends.

Therefore, there is a need in the art for a system and method for providing a social networking platform that allows users to be rated in complex manners and develop reputations based specifically on topics without the need to transfer to different systems to develop reputations across multiple topics. Furthermore, there is a need in the art for a system and method for providing a social networking platform that predicts the usefulness of particular content for a particular user. Finally, there is a need in the art for a system and method for providing trust based relationships for reputation analysis

Another common element of social networking systems is virtual currencies. Virtual currencies are typically used within the social networking system to purchase virtual goods or services and may even sometimes be traded for real world currencies. However, these virtual currencies are typically fixed in price and do not allow for volatility or fluctuations in currency markets. Therefore, the value of a fixed price virtual currency may become skewed in terms of real world currency values.

Therefore, there is a need in the art for a system and method for providing a virtual currency that allows for corrections in value, based on market volatility, fluctuations and other demands of currency investors. Additionally, there is need in the art for a virtual currency that allows for the purchase of real goods and services, such as advertising space or private storage space etc.

These and other features and advantages of the present invention will be explained and will become obvious to one skilled in the art through the summary of the invention, drawings, brief description of the drawings and detailed description that follows.

### SUMMARY OF THE INVENTION

The present invention provides a content evaluation and social networking platform capable of overcoming the shortcomings of previous social networking platforms. The social networking platform of the present invention provides systems and methods for allowing users to define aliases based on various roles of their life, allowing users to rate content and have their content rated in a manner that more accurately predicts the true value of the content for the current observer and allowing users to use, exchange and trade virtual currencies at varying rates based on numerous factors.

According to embodiments of the present invention, a system and method for observer-centric Internet content evaluation and grading system is provided. The system and methods herein described overcome the challenge of scoring types of content effectively and placing content items appropriately according to accurately calculated relevance to a user. Relevance of information displayed to each unique user is specific to that individual.

According to embodiments of the present invention, a social networking platform is provided, whereby a user may identify various aspects or roles (e.g., work, friends, family, student) and create one or more aliases for each aspect or role identified by said user. The parameters and content associated with each alias may be defined by the user.

According to embodiments of the present invention, a social networking platform is provided, whereby each entity (e.g., user, alias, organization, forum post, blog entry, comment) has a reputation matrix. The reputation matrix is comprised of one or more reputations that are domain specific. In this aspect, numerous reputation matrices may be developed and processed in order to provide complex reputations for an entity as it relates to a plurality of other entities.

According to embodiments of the present invention, a social networking platform is provided, whereby the reputation of an entity is affected by one or more grades received from one or more grading entities either directly or indirectly by the means of grades received by related entities and the correlation factor between the observed entity and related entities. The effect of each of the one or more grades is in proportion to the reputation of each of the one or more grading entities. The effect may be further in proportion to the reputation of each of the one or more grading entities within one or more domains of the graded entity.

According to embodiments of the present invention, a social networking platform is provided, whereby a grading entity may grade an entire grouping of other entities (e.g., an entire thread of forum posts) and may also provide a prediction of a grade for entities that are yet to be created.

According to embodiments of the present invention, a social networking platform is provided, whereby the reputation of an individual user or alias is dynamic and may be different depending on the entity viewing the reputation and the specific point in time the viewing occurs.

According to embodiments of the present invention, a social networking platform is provided, whereby a virtual currency exchange system allows users to trade virtual currencies for values based upon real world currencies (e.g., US Dollars, Euros, Pounds, Yen).

### BRIEF DESCRIPTION OF THE DRAWINGS

FIG. 1 is a schematic overview of a network system for carrying out this invention in accordance with an embodiment of the present invention;

FIG. 2 is a flowchart describing an exemplary reputation management method in accordance with an embodiment of the present invention;

FIG. 3 is a flowchart describing an exemplary virtual currency management method, including virtual currency management for values based upon real world currencies, in accordance with an embodiment of the present invention; and

FIG. 4 is a schematic overview of a content evaluation and social networking platform module in accordance with an embodiment of the present invention.

### DETAILED SPECIFICATION

The present invention generally relates to online social networking and online content and general grading system. Specifically, this invention relates to a system and method for providing a social networking platform that allows users to interact through the use of various roles, develop reputations through a personal and peer based rating system and exchange goods and services through use of an online currency that may be traded and exchanged in various real world currencies.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

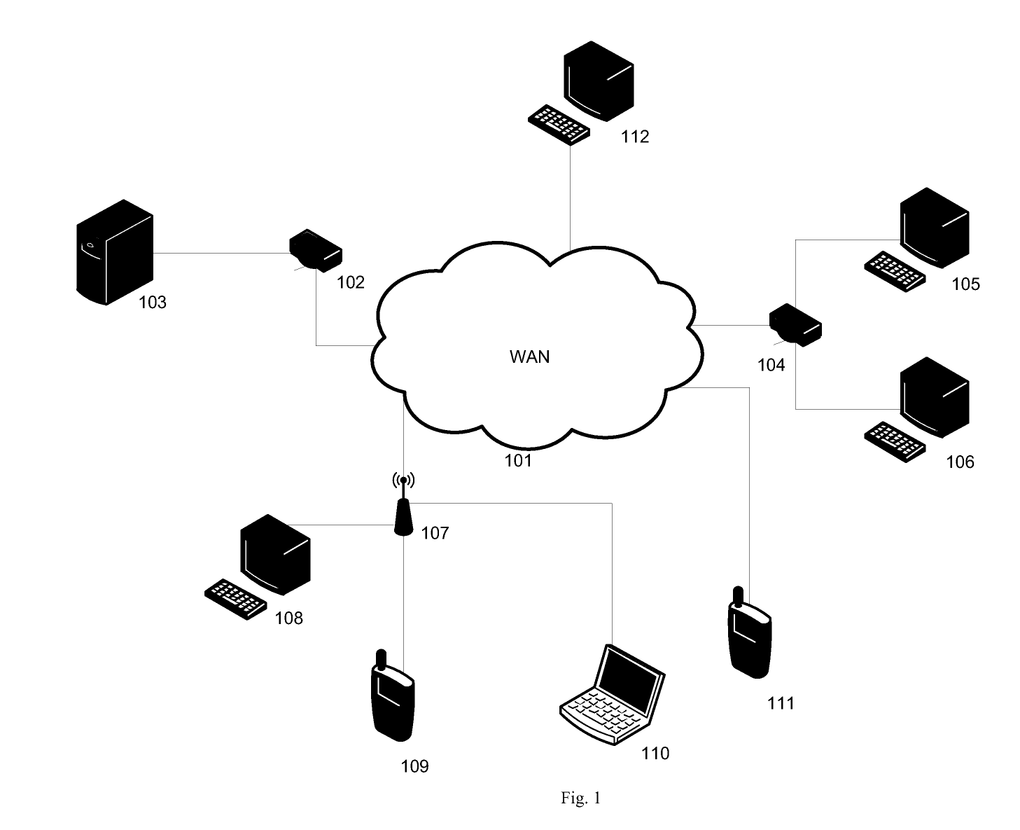

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Members may connect to server 103 via WAN 101 or other network in numerous ways. For instance, a Member may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a member may connect to Server 103 via WAN 101 or other network, and embodiments of the present invention are contemplated for use with any method for connecting to Server 103 via WAN 101 or other network.

According to an embodiment of the present invention, an individual or organization may signup to become a user of the system herein provided. In an exemplary embodiment, an individual or organization would go through a registration process, whereby they would provide identifying information to be stored in application server 103. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes.

According to an embodiment of the present invention, once an individual or organization has completed the initial registration process, the registered user may begin to use the processes and function associated with the social networking platform herein described. In an alternate embodiment, the systems and methods herein described may be utilized by anonymous users without the requirement for registration. Some of the features may not be available to completely anonymous users. However, identifying information (e.g., IP address, cookies) could be used to provide a pseudo-registration for anonymous users, thereby allowing anonymous users access to all the features of the systems and methods herein described.

Aliases

According to an embodiment of the present invention, a user may be provided the ability to create one or more aliases. An alias is designed to represent one or more “roles” the user performs or carries on in real life. For instance, an individual may be a parent, an employee, a spouse, a member of a political party and a member of a local organization. Additionally, an individual may have more than one role within a single organization (e.g., board member, CEO, shareholder). In many instances, the aforementioned individual may want to keep these one or more roles separate from the others. For instance, the individual may find it unnecessary or unwanted to share her membership in a political party with the other individuals she works with. By having a single sign-on point formed through the registration process and allowing a user to create numerous aliases, the user can effectively separate out the various roles of their life.

According to an embodiment of the present invention, a user may be given a unified content area. This unified content area may be associated with the user's main registration (e.g., the root) and provides a place where the user can place content for use with one or more of the user's roles. Content may include, but is not limited to, photos, videos, blogs, links or widgets to external social media profiles (e.g., Twitter, Facebook, Myspace, Xanga, LinkedIn), and profile information (e.g., name, age, gender, height, weight, likes and dislikes, employment, address). From the unified content area, the user may select which aliases have access to each individual piece or type of content.

According to an embodiment of the present invention, a user may be given a alias content area for each alias the user creates. This alias content area may be associated with a particular alias and provides a place where the user can place content for use with a particular alias. Content stored in an alias content area may be shared with or transferred to other alias content areas or the unified content area.

In accordance with an embodiment of the present invention, organizations and groups (“organizational users”) may also register with the online social network platform herein described and create one or more aliases. Organizational users are provided similar functionality to individual users, whereby the organizational user may be provided a unified content area as well as the ability to define themselves through aliases, each with its own alias content area.

Organizational users may also be provided with the ability to be treated as complex systems that are comprised of other users (organizational or individual). According to an embodiment of the present invention, an organizational user may be allowed to control which individual user aliases are allowed to connect with or use the organizational user's name and functionality. For instance, an organizational user may be granted the option of verifying the employment status of an individual user's alias.

Reputation

The social networking platform herein described may be configured in such a manner as to identify each and every individual base unit of identification as an entity. Entities include, but are not limited to, users, aliases, organizations, groups, forum posts, blog entries, blogs, comments, videos and pictures. Each entity is associated with a reputation matrix. The reputation matrix identifies a plurality of reputations based on numerous actions that have been taken either by the entity, by actions other entities have exerted upon the entity and by actions other entities have exerted upon related entities or any combination thereof. Actions that may be taken include, but are not limited to, grading, direct views, indirect views (e.g., entity was included in another entity-quoting), inclusion in search results and referrals.

In addition to the previously mentioned actions, numerous actions are contemplated for use with embodiments of the present invention that have not been previously used in the art. For instance, a user may grade a whole thread of posts as opposed to the individual posts in the thread. Also, reputations can be joined and/or generalized so that individual grades of posts can be “translated” into reputations of a thread, and the reputation of threads can be “translated” into one or more reputations of one or more lists of threads (for example, a “editor composed” newspaper etc.). Additionally, alias reputations may be joined and/or generalized into a user reputation.

The use of reputation matrices comprised of a plurality of reputations allows for each user and each alias to observe a different reputation as it relates specifically to that user. For instance, an entity may have a high reputation with one particular user, and a completely different reputation for another user. In this manner, users may be better presented with entities that are pertinent (i.e., have a high reputation) to them.

Another unique advantage of using entity based reputation through the use of reputation matrices is that the reputation of an entity for different readers evolves differently over time. As actions are taken on an entity, the values in its reputation matrix are updated accordingly. As each particular reputation is updated in the reputation matrix, so too does the entity's relevance to other users and aliases. Also, as an entity's reputation matrix changes, the relevance of other entities to the entity changes as well (e.g., evolves over time). For example, if a user were to view a certain high tech post while the user was a “newbie,” the post may have small influence on the user and thus its reputation for the user should be low. After the user evolves in the domain, the same post bears a different value—even when there have been no actions taken upon the post—and thus a higher reputation for the user. The difference in value is not because the post changed, but because the user (i.e., the observer) have changed.

According to an embodiment of the present invention, the weight and value of each action may vary. For instance, the weight and value of an action may be determined at least in part by the reputation of the entity taking the action. In this manner, if a user or alias with a high reputation in a domain grades an entity with a high mark, the reputation of that entity within the specific domain may be increased more than it would have been if it received a high mark grade from a user of alias with a low reputation in the domain. It is also important to note that there are certain instances where receiving a high mark grade from a user or alias may actually lower the reputation of the entity as it relates to a domain.

According to an embodiment of the present invention, the use of reputation matrices and reputations also works to affect the content that is presented to the various users and aliases of the social networking platform herein described. One way this occurs is that instead of a user or alias defining their own reputation, their reputation is assessed and assigned to them by the actions of entities they are or have been associated with. For example, a particular user may consider them an expert in a certain field. However, if others have taken actions against the various entities associated with that user or the user's aliases that make the user's or alias's reputation only mediocre in that certain field, that user or alias, when requesting, may be presented with materials that more suitably match that user's or alias's reputation.

In this light, a user or alias may be better presented with entities, materials, information and other content that is more suitable to their actual needs. For example, a person may consider himself an expert in mathematics. However, through his numerous submission and presentation of entities in the social networking platform herein described, his reputation, as determined by actions taken on his entities, has clearly classified him at a different level of comprehension that what he himself believes. When he searches for content or other entities on a topic, he may be presented with entities that more closely match his reputation, as such content may be more appropriate to his actual skill level.

This is not to say that users or aliases that have developed a reputation cannot have access or will not be presented content that is not aligned with their reputation. The content and entities may still be available to users and aliases with disparate reputations, however the content and entities may not be at the top of search results on a topic requested by the user or alias. One of the major advantages of this is providing entities and content to a user that would most closely match a user's or alias's true interest, devoid of, in part or in whole, how they view themselves.

Another advantage of the system and methods herein described, through the use of reputations and reputation matrices, is that by allowing reputation to be a variable that changes overtime, the pertinence or relevance of any particular entity may change as well. In this manner, a new user or alias might not only have a low reputation in numerous domains, but also the system may not have enough data to accurately provide entities to that user or alias due to the lack of reputation. The longer a user or alias has used the system, taking actions on entities and having entities take actions on its entities, the system learns and develops its understanding of the user or alias. Early in a user's or alias's existence in the system, the reputation of entities presented to him or her may noticeably vary from one viewing to the next. However, as the user or alias spends more time taking actions and having actions taken on their entities, the system develops an understanding of that user or alias and the variance of reputation in between the viewings of an entity may decrease.

According to an embodiment of the present invention, new entities that have not yet developed a reputation of their own may be able to take on the reputation of the author in the domain of the entity. In this manner, new content is not inappropriately unavailable or hard to find for others in the domain. Once the new entity has had time to develop its own reputation, it may devoid itself of its author's reputation and develop its own reputation matrix.

According to an embodiment of the present invention, reputation may also be affected by certain affiliations a user or alias has. For instance, entities associated with a friend of a user may have a higher reputation simply based on that relationship. Conversely, entities associated with a opposing user or alias (e.g., opposing political party) may have a lower reputation based on that relationship.

Tagging

According to an embodiment of the present invention, entities may be “tagged.” Tagging of entities allows entities to be related to one or more domains. In this manner, domains are not necessarily predetermined and the number of domains is not limited in any particular manner. Additionally, combinations of two or more tags may be used to form distinct domains.

Reputations of a user or alias in relation to a particular domain may be based upon interactions with entities in a domain, based upon interactions in a related domain (e.g., an interaction on an entity that is tagged in more than one domain) or any combination thereof

Filtering

By providing users the ability to create aliases and breaking content out into defined areas where certain content is only available or stored in certain content areas (e.g., unified content area, alias content area) and by developing reputation matrices for every entity, the social networking platform herein described may also provide its users with unique and detailed methods for indexing and searching for content. Since content is broken down by aliases that represent different roles of the user's life, the user may specifically search or filter content based on the various aliases under the control of that user. For instance, a user who has an aliases that have conflicting agendas or points of interest (e.g., employer has conflicting views with a community group associated with the user), the user may select a particular alias to search for content under or filter content through the “eyes” of a particular alias. In this manner, content may be sorted or identified based on particular variables associate with a particular alias.

According to an embodiment of the present invention, the social networking platform herein described may also allow users and aliases to search or sort content based on either their reputation in a particular domain or they may select a reputation to use in place of their own reputation. In this manner, the user may utilize the knowledge and understanding of the user the system has developed, or alternatively, the user's own chosen reputation level. This may be useful when the user wishes to search for or filter results in a reputation level that is not associated with him or his aliases. For instance, if a user was a college professor with a high reputation in a domain, he may have a desire to search for articles written by students or others with a lower reputation in that domain to get a feeling for how their understanding of the domain differ. Conversely, a student with a low reputation in a domain may wish to get a feel for more prominent entities in that domain, so the student would wish to search entities with a higher reputation than the student's own.

According to an embodiment of the present invention, a relation between different domains where a user or alias has participated can be established. A relation may be used for establishing cross domain boundary influences on a user's or alias's reputation. A relation may also be used to calculate a reputation of a user or alias in domains that the user or alias has not yet directly participated in.

According to an embodiment of the present invention, a filter can be created based on tags specifying domains and other relevant properties of certain entities. Entities may be categorized, for example, by: permanent attributes that are set at a creation time of an entity (e.g., creation time, keywords, content); and/or variable attributes that may change with time (e.g., number of views, number of followers).

According to an embodiment of the present invention, entities may be related to taxonomies that can be: inherent (e.g., consisting of categorization of entities by creation time author, etc.); predetermined or “listed” by entities (e.g., specified by stating the taxonomy entities, terms and relations between them); and/or computed (e.g., generated by establishing a metrics rule between the taxonomy terms).

According to an embodiment of the present invention, taxonomies can be stored for later use in a hierarchical view that resembles classical tree-view menu. This user specific tree-view menu system may then be used as a major navigation method by the systems herein described.

In other words, filtering may be based on any subset of attributes that an entity has as well as on number of entity constituents and on relations that the entity has, whether to the observer or to other entities. For example, the system may enable users to sort and filter both threads and single posts by properties such as whether users “like me” liked or did not like those threads or posts.

One of ordinary skill in the art would appreciate that the system may provide search functionality that duplicates or mimics the filtering functionality herein described.

Virtual Currency

According to embodiments of the present invention, the social networking platform may allow users and aliases the ability to buy, sell and trade a virtual currency. The virtual currency is to be similarly situated as those currencies used throughout the world. The virtual currency, in accordance with embodiments of the present invention, may be comprised of exchange rates variably linked to real world currencies. In this embodiment, as rates fluctuate for real world currencies, so too will the rates for the virtual currency vary based on demand and through the bidding, buying and selling of the virtual currency on a currency exchange.

Furthermore, according to embodiments of the present invention, the virtual currency may be implemented in such a manner as to allow financial concepts utilized in the real world to be utilized in relation to the virtual currency. For example, securities, bonds, treasuries and other such financial instruments may be bought and sold for the virtual currency. Additionally, taxes and other administrative fees may be levied against transactions utilizing the virtual currency.

According to an embodiment of the present invention, the social networking platform herein described may act like a state when operating, controlling and managing this virtual currency. For instance, the social networking platform may control the total amount of virtual currency in circulation, thereby creating a virtual financial instrument that has a determinable real world value in numerous real world currencies or other tangible or intangible properties.

Micro Moderation

According to an embodiment of the present invention, the system and methods herein described may be configured to provide a social networking platform that allows for moderation by all registered users. In this manner, high reputation users or aliases in a given domain may command moderating power in that domain. Moderating powers may be granted to a user or alias if a threshold of other users or aliases have rated the user highly. Various levels or tiers of powers may be granted, potentially with more users and fewer powers accessible at lower levels or tiers and fewer users and more powers at higher levels or tiers. One of ordinary skill in the art would appreciate there are numerous ways to setup moderation and administrative privileges based upon tiered structures, and embodiments of the present invention are contemplated for use with any methods of configuring tiered moderation and administrative privileges.

Multilingualism

According to an embodiment of the present invention, the systems and methods herein described may be configured in such a way that both interface and content may be switched to different languages. In this manner, multilingual readers may have content presented in more than one language at the same time.

Statements of Interest

According to an embodiment of the present invention, an aliases or users may choose an option to “consider” another entity, user or alias as a statement of interest. A match may be displayed to the parties only after two or more of them (i) consider each other. Additionally, the system may be configured to require the reputations of the two or more users, aliases or entities to be comparable or compatible in one or more domain.

### Exemplary Embodiments

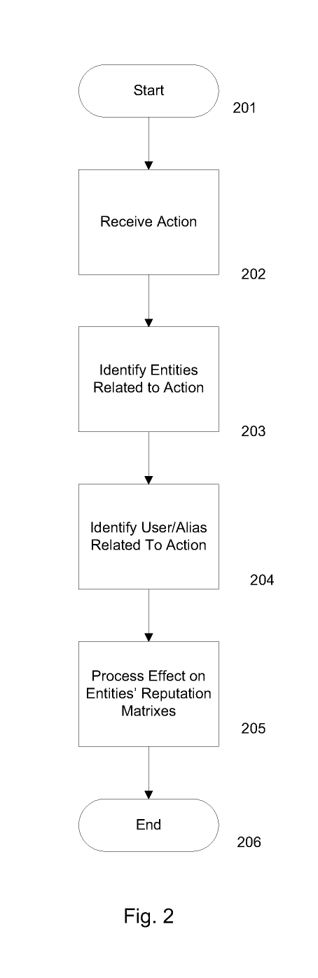

Turning now to FIG. 2, an exemplary embodiment of the reputation management methods, in accordance with an embodiment of the present invention, is described. The process starts at step 201. At step 201, a user or alias has created an action that will affect the reputation matrix of one or more entities.

At step 202, the social networking platform herein described receives the action from the user or alias. The action may be one or more of the actions described previously in herein. The received action may be further comprised of metadata that is capable of identifying the user or alias submitting the action and capable of identifying the entity or entities the action is to take place on.

At step 203, the metadata associated with the action is used to identify the entity or entities related to the action. At this point, the social networking platform may begin to load information related to the entity or entities as may be required by the later steps of the exemplary process herein described. For instance, the social networking platform may begin to load information that identifies the type of entity or entities the action is taking place on, one or more domains related to the entity or entities and the reputation matrix or matrices associated with the entity or entities.

Optionally, at step 203, the online social networking platform may also check to see if the action is a type of action that is permissible to occur on the entity or entities. This optional step may serve to validate the request and to prevent invalid or incomplete actions to be taken against an entity or entities.

At step 204, the metadata associated with the action is used to identify the user or alias that is taking the action on the entity or entities. At this point, the social networking platform may begin to load information related to the user or alias as may be required by later steps of the exemplary process herein described. For instance, the social networking platform may begin to load information that identifies the user or alias taking the action, the reputation matrix associated with the user or alias, the domains in which the user or alias partake in and the privileges of a particular user or alias.

Optionally, at step 204, the online social networking platform may also check to see if the user or alias is permitted to take this type of action on the identified entity or entities. This optional step may serve to validate the action and to prevent invalid or incomplete actions from being taken against an entity or entities.

At step 205, the social networking platform begins to process the effect the action has on the entity's or entities' reputation matrix or matrices. This includes updating the reputation matrix or matrices in response to one or more domains associated with the entity or entities, the action and the user or alias taking the action. Several variables must be taken into account in order to properly update the reputation matrix or matrices of the entity or entities. First, the reputation matrix of the user or alias taking the action must be analyzed, comparing each domain the user or alias has a reputation in against the domains associated with the entity or entities. This analysis may be further processed in relation to the type of action being taken.

Second, the resulting analysis is utilized to update the reputation matrix or matrices of the entity or entities. The update could be a positive, negative or neutral effect on one or more individual reputations in the entity's or entities' reputation matrix or matrices. If an entity is a complex entity, such as a thread of forum posts, or an organizational user, the social networking platform may also process cascading reputation matrix implications. These cascading reputation matrix implications may require the updating of reputation matrices belonging to one or more separate entities.

At step 206, the process is complete and the action is duly recorded in relation to the affected entity or entities. The previous steps are merely for example purposes. The steps are not required to be executed in this order, and one of ordinary skill in the art would appreciate that these steps could be executed in a variety of different manners as well as having two or more of the steps executing simultaneously.

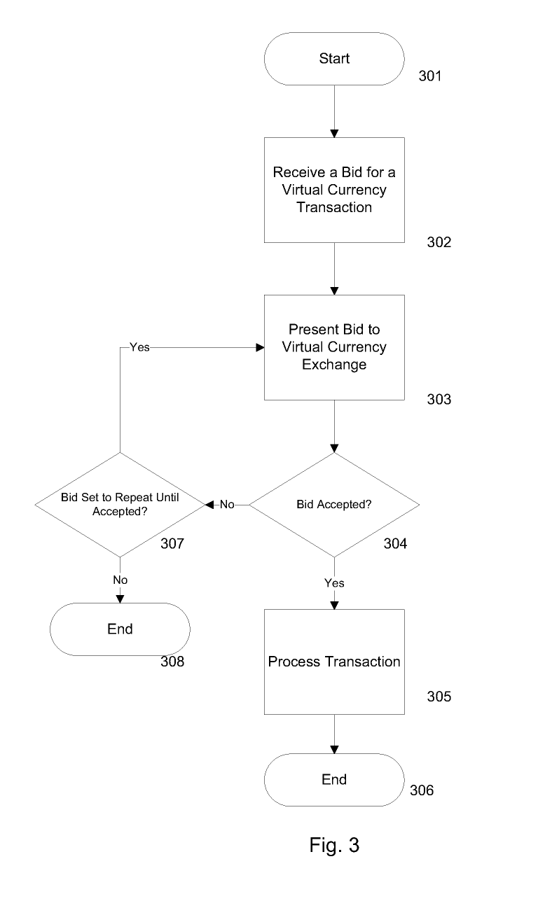

Turning now to FIG. 3, an exemplary embodiment of the virtual currency transaction methods, in accordance with an embodiment of the present invention, is described. The process starts at step 301. At step 301, a user or alias is creating a bid to execute a financial transaction involving the virtual currency managed, at least in part, by the social networking platform herein described. One of ordinary skill in the art would appreciate that the financial transaction could be any number of transaction types, including, but not limited to, a bid purchase an amount of virtual currency at a given price that corresponds with one or more real world currencies, a bid to sell an amount of virtual currency at a given price that corresponds with one or more real world currencies and a bid to buy or sell an amount of virtual currency at a market price that corresponds to a real world currency.

At step 302, the bid is received at the social networking platform. At this point, the social networking platform may identify a variety of data points related to the bid, such as the transaction type, the transaction amount, transaction currencies (e.g., virtual currency, real world currency or any combination thereof), validity of the transaction as well as the user or alias that submitted the bid. This information may be contained, for instance, within metadata associated with the bid.

At step 303, the bid is validated and posted to an online virtual currency exchange that is part of the social networking platform. In this step, the bid becomes part of a live online virtual currency exchange, where the bid may be acted upon by one or more other users or aliases that wish to accept part or all of the bid. The bid may be based, at least in part, upon one or more of a virtual currency value, real world currency value or any combination thereof

At step 304, any participating user or alias may elect to accept or reject the bid. The rejection of bids may either be explicit (e.g., affirmatively reject the bid) or implicit (e.g., ignoring the bid). If a user or alias rejects the bid, the process proceeds to step 307, whereby the social networking platform determines if the bid is set to continue to be live (e.g., a bid that is set to be live for a given duration). If the bid has been rejected, and it is determined that the bid is set to repeat until it is accepted, the bid returns to the pool of yet to be accepted bids.

If no one accepts the bid, and the bid is not set to repeat, then the process ends at step 308. The user or alias that posted the bid may be alerted to the failure to consummate a transaction and presented with the opportunity to repost a bid.

If the bid is accepted at step 304, the process continues to step 305, where the transaction is processed. In this step 305, the settlement process may begin, whereby the transfer of the virtual currency may occur as presented in the bid. For instance, the virtual currency could be exchanged for one or more of a defined amount of real world currency, a defined amount of publicly traded real world securities, a defined amount of privately traded real world securities, real world goods or services, tangible property, intangible property or virtual goods or services.

At step 306, the process ends with the settlement of the transaction. The social networking platform may also record part or all of the transaction for numerous purposes, including legal and compliance purposes. The previous steps are merely for example purposes. The steps are not required to be executed in this order, and one of ordinary skill in the art would appreciate that these steps could be executed in a variety of different manners as well as having two or more of the steps executing simultaneously.

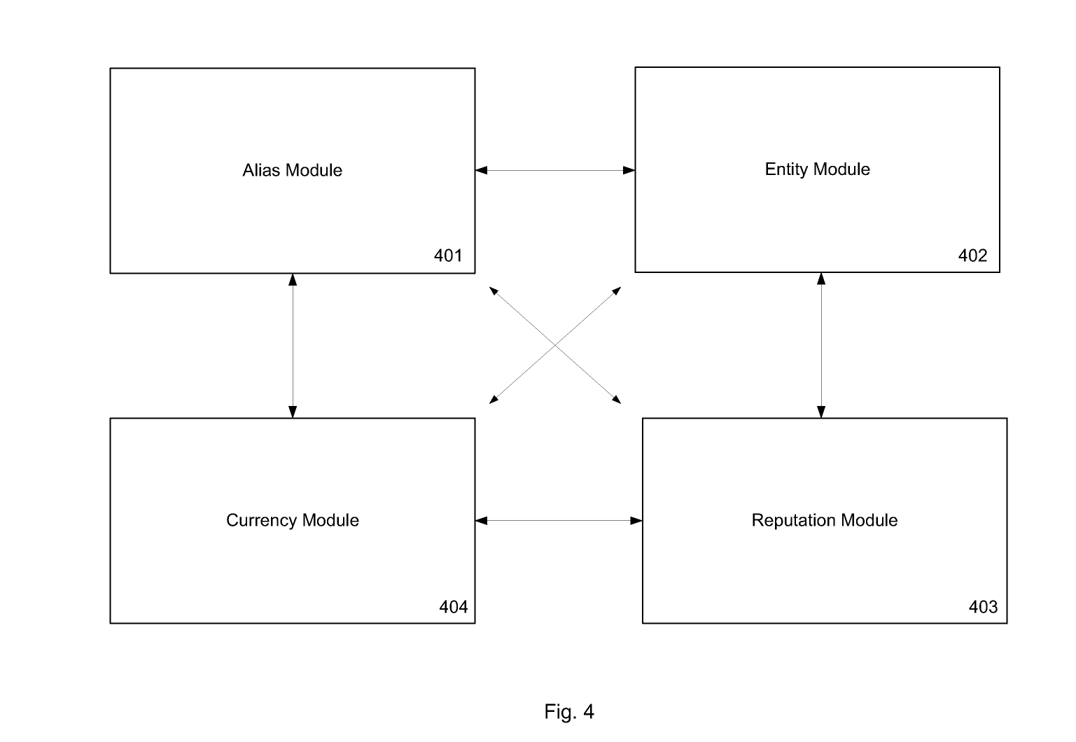

Turning now to FIG. 4, an exemplary embodiment of the social networking platform as described herein is shown. In this exemplary embodiment, the social networking platform is comprised of an Alias Module 401, an Entity Module 402, a Reputation Module 403 and a Currency Module 404.

The Alias Module 401 is capable of receiving, storing, processing, updating, deleting and otherwise managing both users and aliases. The Alias Module 401 is communicatively connected to the Entity Module 402, the Reputation Module 403 and the Currency Module 404.

The Entity Module 402 is capable of receiving, storing, processing, updating, deleting and otherwise managing entities and all associated content or other information related to entities. The Entity Module 402 is communicatively connected to the Alias Module 401, the Reputation Module 403 and the Currency Module 404.

The Reputation Module 403 is capable of receiving, storing, processing, updating, deleting and otherwise managing reputations and reputation matrices, including the domains in which the various reputations and reputation matrices are affiliated with. The Reputation Module is communicatively connected to the Alias Module 401, the Entity Module 402 and the Currency Module 404.

The Currency Module 404 is capable of receiving, storing, processing, updating, deleting and otherwise managing virtual currencies and transactions related thereto. The Currency Module 404 is communicatively connected to Alias Module 401, the Entity module 403 and the Reputation Module 403.

One of ordinary skill in the art would appreciate that the modules herein described as part of the exemplary embodiment of the present invention could be located on one or more servers or other computing devices and could be located at the same location or remote from one another. Furthermore, one of ordinary skill in the art would appreciate that there are numerous ways to combine the various modules described and they need not be separate or disperse entities. Additionally, the modules could be further subdivided into specialized modules defined by particular routines or subroutines. Finally, one of ordinary skill in the art would appreciate that a social networking platform as defined herein may be operable without one or more of the aforementioned modules, and while some of the features or methods may not be available without one or more of the modules, the rest of the systems and methods herein described would continue to work unabated.

According to an embodiment of the present invention, the systems and methods herein described may be made accessible to third-party systems for use and consumption remotely. For instance, application programming interfaces (APIs) may be provided that allow for portions or all of the systems and methods herein described to be utilized on third-party systems. One of ordinary skill in the art would appreciate that there are numerous ways to expose portions of a system's functionality to third-party systems, and embodiments of the present invention are contemplated for use with any manner of exposing portions of the system to a third-party system.

In the aforementioned manner, a comment or other action could be taken on a third-party website and that comment or other action could be instantaneously given a reputation or be associated with a reputation matrix as previously described herein. This includes, but is not limited to, importing reputations from one or more existing reputation matrices or generating a new reputation matrix for the comment or other action.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for providing reputation matrices for a social networking platform, said method comprising:
receiving, at a social networking platform, an entity from a first alias associated with a first user;
processing, at said social networking platform, a reputation matrix, associated with said entity,
wherein said reputation matrix is comprised of a plurality of reputations, wherein said plurality of reputations is based, at least in part, on a reputation associated with said first alias;
receiving, at said social networking platform, an action related to said entity from a second alias associated with a second user;
updating, at said social networking platform, said plurality of reputations based, at least in part, on said action related to said entity; and
providing, from said social networking platform, said entity to a third alias associated with a third user, based, at least in part, on one reputation of said plurality of reputations.

2. The method of claim 1, further comprising the step of updating the plurality of reputations based, at least in part, on said providing of said entity to said third alias associated with said third user.

3. The method of claim 1, wherein said entity is a piece of content associated with said first alias of said first user.

4. The method of claim 1, wherein said entity is a alias.

5. The method of claim 1, wherein said first alias of said first user corresponds with a distinct role in the life of said first user.

6. The method of claim 1, wherein each reputation of said plurality of reputations corresponds to a unique entity.

7. The method of claim 1, wherein said action related to said entity is a grading action.

8. The method of claim 1, wherein said action related to said entity is a viewing action.

9. A system for providing a social networking platform utilizing reputation matrices, the system comprising:
a alias module,
wherein said alias module is capable of creating and managing one or more aliases related to one or more users of said social networking platform;
an entity module,
wherein said entity module is capable of receiving and processing one or more entities from said one or more aliases related to said one or more users associated with said alias module;
a reputation module,
wherein said reputation module is capable of creating and managing a plurality of reputation matrices,
wherein each reputation matrix of said plurality of reputation matrices is comprised of a plurality of reputations,
wherein in each reputation matrix of said plurality of reputation matrices is associated with one of said one or more entities associated with said entity module,
wherein said reputation module, entity module and alias module are communicatively connected.

10. The system of claim 9, wherein each entity of the one or more entity is a piece of content.

11. The system of claim 9, wherein each entity of the one or more entity is an alias.

12. The system of claim 9, wherein said reputation module is capable of processing one or more actions received from said alias module.

13. The system of claim 12, wherein said one or more actions are comprised of at least one action that is a grading action.

14. The system of claim 12, wherein said one or more actions are comprised of at least one action that is a viewing action.

15. The system of claim 12, wherein said processing includes updating at least one reputation in said plurality of reputations contained in at least one reputation matrix of said plurality of reputation matrices.
